(19) United States
(12) Patent Application Publication
(10) Pub. No.: US 2011/0018682 A1
(43) Pub. Date: Jan. 27, 2011

(54) PHYSICAL, EDUCATIONAL AND OTHER ACTIVITY BASED PRIVILEGED ACCESS AND INCENTIVE SYSTEMS AND METHODS

(76) Inventor: Eugene Weisfeld, Santa Fe, NM (US)

Correspondence Address: Ortiz and Lopez, PLLC;Registered Patent Attorneys, P.O. Box 4484, Albuquerque, NM, 87196, US

(21) Appl. No.: 12/510,004

(22) Filed: Jul. 27, 2009

(51) Int. Cl. G06F 7/04

(52) U.S. Cl. 340/5.7; 340/5.2

(57) ABSTRACT

A physical activity, educationally required activity and other required activities monitoring system and method for providing a privilege access to user-intended devices based on completion of a physical activity by a user. The monitoring system includes a monitoring module associated with at least one monitoring device, at least one sensor, a box and a key pad lock. The activity monitoring module can be programmed to open the box or other “lockable” enclosed space (physical or electronic) associated with the user-intended devices after a predefined time limit is attained or required activity is completed. The monitoring device can be programmed and can be read wirelessly and/or by “plugging” the sensing device into the monitoring module. A wireless signal can be transmitted to open the box or other “lockable” enclosed space and the user-intended devices can be obtained or activated if the physical criterion is attained. If the programmed criterion is not attained, the box and the keypad lock can “punish” the user by preventing access to the user-desired activity or devices.

### TECHNICAL FIELD

Embodiments are generally related to monitoring systems used in a variety of activities. Embodiments are more particularly related to physical activity based privileged access and incentive systems, methods and monitoring systems for use in a variety of physical activities. Embodiments are also related to methods and systems for motivating a user to engage in one or more of these activities. Embodiments are also generally related to monitoring systems for use in a variety of physically related activities. Embodiments are also related to methods and systems for motivating a user to engage in educational or other required and measurable activities. Embodiments are also related to methods and systems for motivating a user to achieve a measurable programmed goal.

### BACKGROUND OF THE INVENTION

It can be difficult to motivate people, particularly people who are physically unfit and/or feel too overweight or obese to engage in physical activities both inside and outside. Outdoor activities are activities such as walking, running, jogging, cycling, swimming and stair climbing. Indoor activities are activities such as riding a stationary bicycle, walking/jogging on a treadmill, using a stair stepper, weight training or taking an exercise class. Individuals with hectic lifestyles, who are fatigued, under great stress, and who have opportunities to spend time playing video games, watching television, or performing other sedentary activities are often unwilling to perform strenuous and often tedious physical activities. Tools for measuring these physical activities are often designed for tracking specific movements such as miles traveled on a tread mill or a stationary bicycle, number of steps taken on a stair stepper or similar machine, etc. In addition there are products that act as a personal (virtual) coach for users and encourage them to perform specific tasks.

While such conventional tools can be useful with highly motivated adults, unmotivated adults, young children, preteens, teens and young adults do not generally engage in physically demanding activities for the purpose of exercise, improved fitness and health promotion but (if they engage in such activities at all) do so for the fun of the activity. Also, motivation to maintain adequate levels of physical activity is often lacking despite such tools. The majority of prior art approaches have adapted a “reward” method in an attempt to motivate young children, preteens, teens and young adults to be physically active by providing incentives that are fun and socially interactive. Such approaches however, can only encourage the user to participate in physical activities and does not require the user to perform the physical activity to a desired extent. Requiring users to perform the desired physical activity to a desired extent in order to get something the user greatly desires, such as use of a cell phone, playing a video game or being able to use a TV or computer, will be a more effective incentive. Such an incentive program is not currently available to the present inventor's knowledge.

Many young children, preteens, teens and young adults are also unmotivated, reluctant and often very resistant to learning and/or completing essential, but often boring, tedious and disliked educational tasks such as completing homework, a school assignment or learning multiplication tables. Motivating the young to complete these essential educational or school related tasks can prove difficult. The approach of rewarding users to complete these tasks, however, can only encourage the user to participate in these activities. Prior systems do not require a user to perform the activity to the desired extent in order to get something the user greatly desires such as use of a cell phone, a video game or the ability to use a TV or computer. The present methods and incentive system can also be used for any task that can be monitored, such as, for example, washing and/or drying clothes, cleaning up a room or similar activity.

Based on the foregoing it is believed that a need exists for an improved method and system for motivating a user to participate in an educational or other required activity. A need also exists for providing privileged access to user desired devices based on completion of the physical activity, as described in greater detail herein. A need also exists for an improved method and system for motivating users to participate in an important and essential and required educational or other school related required activity. A need also exists for providing privileged access to user-desired devices based on completion of the required educational or other school related activity, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved physical activity monitoring method and system.

Another aspect of the present invention is to provide for an improved educational or other required activity monitoring method and incentive system.

It is a further aspect of the present invention to provide for an improved method and system for providing privileged access to user devices based on completion of the physical activity.

It is another aspect of the present invention to provide for an improved method and system for providing privileged access to user-desired devices based on completion of an educational or other required activity.

The aforementioned aspects, objectives and advantages can now be achieved as described herein. A monitoring system and method can be used for providing privileged access to the user-desired devices based on completion of a physical activity by a user. The monitoring system can include a monitoring device (e.g., meter) and at least one sensor. The monitoring system can also include a wirelessly controlled lock that can be used to open a box, a room, a cabinet or any other enclosure which can be locked and unlocked remotely based on input from the monitoring system. The monitoring system can also include a removable cartridge (e.g., “flash card”) that can be inserted into a system that enables a monitored user's desired activity (e.g., game console or television set) in order to enabled the desired activity. The monitoring devices can be powered utilizing an electric cord and/or a rechargeable battery to produce the necessary electricity. The sensor can also be RFID tag- and Bluetooth wireless-enabled. The monitoring system can measure all the factors of heart beats (e.g., number per minute, duration, peaks and valleys, etc.) and can be the most useful attribute measured by the monitoring system since it can be used in all physical activity to obtain at least one unit measurement. The monitoring device, or a part thereof, can also be wirelessly connected to a wrist worn display that informs the monitored user if s/he is performing to the programmed requirements. The wrist worn display can also include a sensor to obtain biometric measurements.

A “programmable and lockable” key pad can also be provided to override the locking functions of the monitoring system by authorized system managers. The activity monitoring module can be programmed into the system to open the “lock” that allows the user to access the user-desired device or devices after a predefined activity has been completed or a specified time has been reached. The monitoring device can also be programmed and can be read wirelessly and/or by “plugging” the device into the monitoring module. A wireless signal can be transmitted to open the lock and the user-desired devices can be activated if the programmed criterion is completed. If the programmed criterion (e.g., wherein a user reaches the goal for an activity) is not completed, a signal is not sent and the lock does not unlock the box or other locked, enclosed space and the user is denied access to or use of the user-desired devices.

As previously described, the monitoring devices that can operate with the monitoring system can include at least one sensor in combination with a monitoring meter. At least one or more sensors can include: a heart rate monitor, a pedometer, a sprint meter, a swimming meter, a standing/sitting meter, a stomach expansion meter, an exercise/weight training meter, and any other form of metering device devised for measuring physical activity by a human. For example, a heart rate monitor that is worn by a user can monitor various biometric attributes such as heart rate, temperature, etc., during an exercise class such as Tai Bo, and even during any physical activity including physical activities that are typically not monitored, e.g., sexual intercourse. As another example, a weight training meter can be used for monitoring activity that comprises a band for measuring expansions of the muscles (such a device has been developed by a group of Japanese scientists for use in monitoring muscle wastage in people with muscle wasting diseases) and the stomach expansion meter comprises an expansion band for measuring expansion of the belly.

A monitoring system, through a monitoring meter and sensor, can record the extent and duration of the physical activities. A programming module in the monitoring system enables an authorized user to program the monitoring system for how long and at what intensity monitored users should engage in physical activities and allows the monitored users access to the desired object which has been “locked” away in a box or other enclosure which only opens when it receives a wireless signal that the programmed criterion or criteria have been completed or reactivates an electronic device, such as, for example, a cell phone, which has been deactivated by the monitoring system. Such an approach results in the denial of a monitored user to desired devices and activities if the required activity is not completed.

It can be appreciated that various monitoring device and various activities are contemplated with the present invention Activity monitoring using the present system can work well in applications with people of any age, and particularly well for young children, preteens, teens and young adults. The same process can be used to motivate people of any age, especially young children, preteens, teens and young adults to complete an educational related or other desired and measurable activity.

### BRIEF DESCRIPTION OF THE DRAWINGS

The accompanying figures, in which some reference numerals may refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a physical activity monitoring system, in accordance with an embodiment;

FIG. 2 illustrates a block diagram showing various monitoring devices for use with the monitoring system, in accordance with an embodiment; and

FIG. 3 illustrates a high level flow chart of operation illustrating a method for providing a privilege access to user-desired devices based on completion of the physical activity, in accordance with an embodiment.

### DETAILED DESCRIPTION

The particular values and configurations discussed in these non-limiting examples can be varied and are cited merely to illustrate at least one embodiment and are not intended to limit the scope thereof.

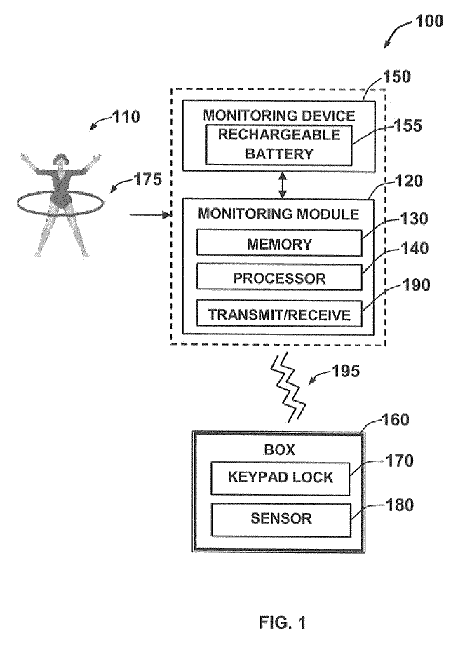

FIG. 1 illustrates a block diagram of a physical activity monitoring system 100, in accordance with an embodiment. The monitoring system 100 generally includes a monitoring device 150, an activity monitoring module 120, a box 160, a keypad lock 170 and a sensor 180. The monitoring system 100 can be utilized to monitor performance of a user 110 via the monitoring device 150 while exercising on a physical activity system 175. It should be noted that although FIG. 1 depicts a monitored user on a spin bicycle, that various other activities are contemplated although they are not pictured. The physical activity system 175 can be aerobic or gym equipment, such as for example, a tread mill, rowing, an elliptical trainer, etc., and weight equipment utilized for the development of various muscles or muscle groups of the user 110. It can be appreciated that the physical activity monitoring system 100 of the present invention can be utilized for monitoring the performance of the user 110 with respect to any physical activity system 175, although not specifically listed or described herein.

The monitoring device 150 can be a portable electronic device that acts as a body-mounted physiological monitor or custom built device. The monitoring device 150 can be attached to the user 110 via a strap, clip, adhesive pad, or other mechanism. Physiological processes or parameters that can be monitored by the monitoring device 150 includes components of respiration, respiration frequency, blood analysis, blood pressure, skin conductivity, lung function, respiratory flow volume, heartbeat, pulse rate, brain activity and processes, physical activity levels, and body temperature, etc.

The activity monitoring module 120 can include a memory unit 130, a processor 140 and a transmit/receive unit 190. The activity monitoring module 120 can be programmed to open the box 160 associated with the user-desired devices (e.g. an electronic appliance) after a predefined time limit is attained. Note that term user-desired devices described herein should not be constituted in any limited sense. The user-desired devices described herein can be any electronic appliance such as for example, but not limited to a television remote control, a video game control, etc which the user 110 really requires.

The monitoring device 150 can be programmed and can be read wirelessly and/or by “plugging” the device 150 into the monitoring module 120. The memory unit 130 can store the measured physiological monitoring parameters obtained from the monitoring device 150. The processor 140 that acts as a remote computer system can monitor and generate the predefined criterion for the monitoring device 150. The transmit/receive unit 190 can be utilized to transfer a wireless signal 195 to the box 160 and the keypad lock 170 and receive designated response from box 160 and the keypad lock 170.

The monitoring module 120 can read the physiological process or parameters of the user 110 and provide a response to the box 160 and the keypad lock 170 via the wireless signal 195. The wireless signal 195 can be sent to the box 160 which then opens the box 160 and the user-desired devices can be activated if the programmed criterion is attained. If the programmed criterion is not attained, the box 160 and the keypad lock 170 “punish” the user 110 by preventing access to the user-desired devices. Further, the sensor 180 can be utilized for recording the extent and duration of physical activity performed by the user 110 on the physical activity device 175. The monitoring system 100 provides motivation for performing physical activities by the users 110 with hectic lifestyles, and spends their time by playing video games, watching television, or performing other sedentary activities.

The monitoring system 100 may vary in the sophistication of its programming for determining when to prompt the user 110 to perform the physical activity and how long to recommend the user 110 to perform physical activity utilizing the pre-selected time limits. The monitoring system 100 continuously or periodically evaluates new inputs regarding any of a wide array of health variables, including those being transmitted at the time by the sensor 180, and values concerning the user's physical status that are previously entered or are retrieved from other data sources. For example, the monitoring system 100 may revise its recommended duration or time limit of exercise upward or downward based on the user's heart-rate being lower or higher, respectively, that had earlier been predicted by the monitoring module 120. The box 160 and the keypad lock 170 prevent access to user-desired devices if the required physical activity is not completed.

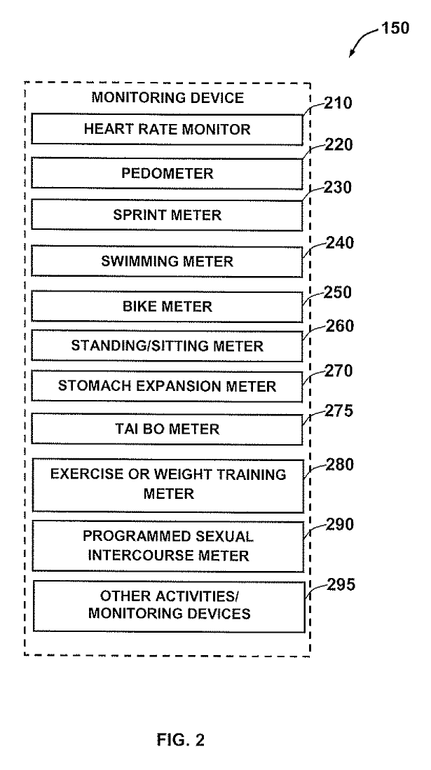

FIG. 2 illustrates a block diagram showing various monitoring devices 150 for use with the monitoring system 100, in accordance with an embodiment. Note that in FIGS. 1-3, identical or similar blocks are generally indicated by identical reference numerals. The monitoring device 150 that can operate with the physical activity monitoring system 100 can include any one of a heart rate monitor 210, a pedometer 220, a sprint meter 230, a swimming meter 240, a bike meter 250, a standing/sitting meter 260, a stomach expansion meter 270, a Tai Bo meter 275, an exercise/weight training meter 280, and a programmed sexual intercourse meter 290.

The heart rate monitor 210 can be a personal monitoring device that measures the heart beat rate of the user 110 in real time and record the heart beat rate for later studies. The heart rate monitor 210 can include a chest strap or band that comprises a sensor to monitor signals with respect to the user activity. The heart rate monitor 210 can additionally measure heart rate variability, activity, and breathing rate that can be utilized to assess parameters relating to the user fitness. Further, the heart rate monitor 210 can transmit a digital or analog signal to the monitoring module 120 representing heart beat of the user 110.

The pedometer 220 can be utilized to monitor the activities such as, walking, jogging, hiking, stair climbing and similar activities with respect to the user 110 and measure the distance walked by the user 110 for a given time period. The sprint meter 230 measures the time taken by the user 110 to travel a distance without necessity of having a timer or other expensive measuring device. The swimming meter 240 senses when a lap has been made by the user 110 in a swimming pool. Also, the swimming meter 240 represents the time taken for achieving the prescribed number of laps in a swimming pool.

The bike meter 250 senses the number of rotations made by the user 110 on a bike wheel within a time period and also represents the hardness exerted by the user 110 on the wheel. The bike meter 250 comprises a band to measure the number of expansions of the muscle. The standing/sitting meter 260 records the number of times the user 110 stands up and sits down. The stomach expansion meter 270 can sense the expansion of the stomach of the user 110. The stomach expansion meter 270 includes a band that can be wrapped to the belly of the user 110. The stomach expansion meter 270 transmits digital signals (representing the expansion in the stomach of the user 110) to the monitoring module 120. The stomach expansion meter 270 can also generate an alarm signal when there is a maximum expansion in the band.

The Tai Bo meter 275 can be utilized to sense the number of kicks and punches performed by the user 110 and the time taken to complete such activities. The exercise/weight training meter 280 can measure preprogrammed activities, such as, squats, pushups, sit ups, certain weight training repetitions or similar activities. The exercise/weight training meter 280 can also measure the time taken to perform such preprogrammed physical activities. The programmed sexual intercourse meter 290 can rely on time and activity.

The monitoring devices 150 can be programmed and the data can be read wirelessly and/or by “plugging” the device 150 into the monitoring module 120 for providing a privilege access to user-desired devices based on completion of the physical activity by the user 110. The predefined time interval can be programmed in association with the monitoring module 120. The monitoring devices 150 can utilize an electric cord or a rechargeable battery 155 for electrical connection.

Note that the embodiments discussed herein should not be construed in any limited sense. It can be appreciated that such embodiments reveal details of the structure of a preferred form necessary for a better understanding of the invention and may be subject to change by skilled persons within the scope of the invention without departing from the concept thereof. For example, a monitoring system can be incorporated into a scale that wirelessly unlocks a locked system only if someone's weight is at or under a certain amount. If access, however, is determined to be necessary despite the condition measured, then the system would be enabled to allow an authorized user (e.g., parent, manager, supervisor) with a code to unlock the electronic system or open the container. The locked system can also include timed locks that allow unlocking even if a monitored user does not achieve a goal (e.g., a person's weight was over the set limit) after a set amount of time.

Where a container is locked by the system, the container can be used to contain items of desire to monitored users. For example, a television or other electronically controlled device remote controller or other desired device can be locked away in the locked container, which would only allow access if unlocked by completing a programmed activity.

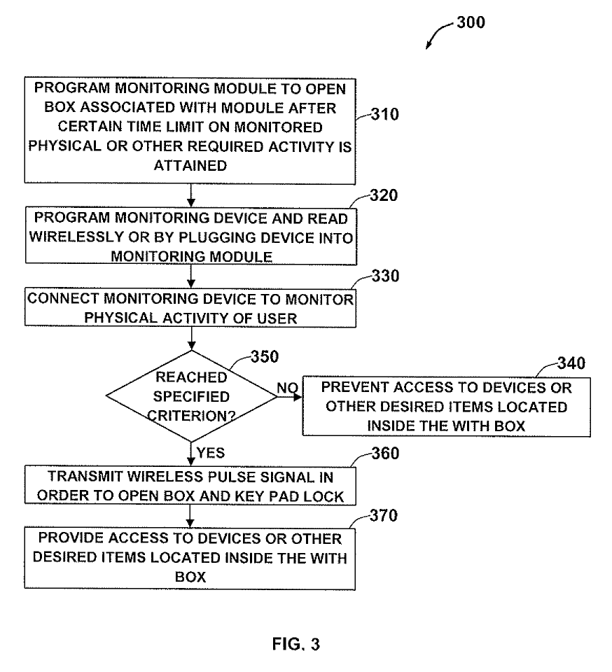

FIG. 3 illustrates a high level flow chart of operation illustrating a method 300 for providing a privilege access to user-desired devices based on completion of the physical activity, in accordance with an embodiment. The monitoring module 120 can be programmed to open the box 160 associated with the user-desired device after a predefined time limit is attained, as depicted at block 310. The monitoring devices 150 can be programmed and can be read wirelessly and/or by “plugging” the device 150 into the monitoring module 120, as illustrated at block 320. The monitoring device 150 can be plugged into the monitoring module 120 in order to provide a significant cost reduction. The monitoring device 150 can be connected to the user 110 to monitor the physical activity with respect to the user 110, as indicated at block 330.

A determination can be made whether the user 110 has completed the physical activity and has attained the specified criterion, as shown at block 350. If the specified criterion has been attained the wireless signal 195 can be transmitted in order to open the box 160 and the keypad lock 170, as illustrated at block 360. Thereafter, as indicated at block 370, access to the user-desired devices (e.g. television remote controls) can be provided. Otherwise, the monitoring system 100 can punish the user 110 by preventing access to the user-desired devices, as depicted at block 340. Such an approach results in the denial of the user-desired devices if the required physical activity is not completed, which works well for adults and for youth.

The physical activity monitoring system 100 motivates the user 110 to take some time to perform physical activity. The monitoring system 100 also provides an indication for how long the user 110 should engage in physical activity, an indication of incentives for engaging in physical activities, and punish the user 110 if the physical activity has not been performed for the preselected time limit. The length of the time interval can be chosen such that the result of the integration is a value that is representative of the type of the movement activity.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for encouraging physical activity based privilege access, comprising:
configuring an activity monitoring system to provide a monitored user access to a locked system after at least one of a programmed activity level is achieved by the monitored user or a predefined time limit is attained;
connecting at least one monitoring device including a sensor to a monitored user in order to monitor activity of the user; and
unlocking said locked system if at least one of said predefined time limit is attained or said programmed activity level is achieved by the monitored user.

2. The method of claim 1, wherein said locked system includes at least one of: an electronic entertainment system or an electronically lockable enclosed space.

3. The method of claim 1, further comprising the step of transmitting a wireless signal to said locked system to unlock it if at least one of said predefined time limits is attained or said programmed activity level is achieved by the monitored user.

4. The method of claim 1 further comprising: plugging said activity monitoring device into said locked system to unlock it if at least one of said predefined time limit is attained or programmed activity level is achieved by the monitored user.

5. The method of claim 1, wherein said sensor provides data to a monitoring meter of the extent and duration of said physical activity and said sensor generates signals indicative of said physical activity.

6. The method of claim 1, wherein said activity is a physical activity including at least one of: bicycling, running, walking, weight lifting, weighing in on a scale, rowing, swimming, resting, sleeping, sexual intercourse.

7. The method of claim 1 wherein said at least one monitoring device comprises at least one of: a heart rate monitor, a thermometer, a blood pressure monitor, a pedometer, a stomach expansion meter, or a weight scale.

8. The method of claim 7 wherein said bike meter comprises a band for measuring expansions of muscles in a user.

9. The method of claim 7 wherein said stomach expansion meter comprises an expansion band for measuring expansion of belly of said user.

10. A physical activity based privilege access system, comprising:
a box for storing access to user-desired device and activity; and an activity monitoring module including at least one sensor configured to monitor physical activity by a user and to enable user access into said box after a predefined time limit for said physical activity is attained by the user.

11. The physical activity based privilege access system of claim 10, wherein said at least one sensor in association with said activity monitoring module is connectable to the user in order to monitor performance by the user with respect to a physical activity.

12. The physical activity based privilege access system of claim 10, wherein said activity monitoring module includes wireless communications for transmitting a wireless signal to said box to enable opening of said box if said physical activity is accomplished by the user.

13. The physical activity based privilege access system of claim 12, wherein said accomplishment of said physical activity by the user is measured in time.

14. The physical activity based privilege access system of claim 10, further comprising: configuring a rechargeable battery in association with said at least one monitoring device for providing electrical connection.

15. The physical activity based privilege access system of claim 10, wherein said at least one sensor further comprises at least one of: a heart rate monitor, a pedometer, a sprint meter, a swimming meter, a bike meter, a standing/sitting meter, a stomach expansion meter, a weight training meter, a Tai Bo activity meter, or a programmed sexual intercourse meter.

16. The physical activity based privilege access system of claim 15, wherein said bike meter comprises a band for measuring expansions of muscles of said user.

17. The physical activity based privilege access system of claim 15, wherein said stomach expansion meter comprises an expansion band for measuring expansion of belly of said user.

18. A activity monitor and privilege access system for providing access to the user-desired devices based on completion of a physical, educational or other required activity by a user, said activity monitor and privilege access system comprising:
a predefined activity monitoring device including at least one sensor;
a wirelessly controlled lock for controlling access to a user-desired activity;
a programmable and lockable key pad; and
an activity monitoring module controlling access to said wirelessly controlled lock and enabling access to said user-desired activity after a predefined activity has been completed by a user.

19. The activity monitor and privilege access system of claim 18, wherein said at least one sensor further comprises at least one of: a heart rate monitor, a pedometer, a sprint meter, a swimming meter, a bike meter, a standing/sitting meter, a stomach expansion meter, a weight training meter, a Tai Bo activity meter, or a programmed sexual intercourse meter.

20. The activity monitor and privilege access system of claim 18, wherein said activity monitoring module includes wireless communications for transmitting a wireless signal to said wirelessly controlled lock to enable opening of said wirelessly controlled lock if said physical activity is accomplished by the user.

21. The activity monitor and privilege access system of claim 18, wherein said sensor at least one sensor includes a weight scale including wireless communications for transmitting a wireless signal to said wirelessly controlled lock to enable opening of said wirelessly controlled lock if a user's weight on the weight scale is a programmed level that enables a wireless signal to be sent to the wireless controlled lock enabling access to a user-desired activity.
